(19) United States
(12) Patent Application Publication
(10) Pub. No.: US 2006/0058936 A1
(43) Pub. Date: Mar. 16, 2006

(54) " Mind of It's Own" automobile security system

(76) Inventor: J. Michael Johnston, Winter Park, FL (US)

Correspondence Address: J. MICHAEL JOHNSTON, 2924 ANTIQUE OAKS CIRCLE, APT. # 48, WINTER PARK, FL, 32792, US

(21) Appl. No.: 10/938,246

(22) Filed: Sep. 13, 2004

(51) Int. Cl. G05D 1/00

(52) U.S. Cl. 701/49; 701/2

(57) ABSTRACT

To Narrate and summarize my invention: I was riding in a car with my friend. After we reached our destination, he proceeded to show off the fact that he could roll his power windows up and down without the keys being in the ignition. I was unimpressed, as I had witnessed this marvel in modern technology before. We exited his vehicle and proceeded on foot to our destination. He and I returned to find that the entire time we were away from his vehicle the passenger side rear window had been opened halfway. I soon initiated the “what if” thought process. The end result was that the technologies in his, and any car, could be easily modified: What if, the windows could be rolled up or down until a door was locked; rather than opened. If that were the case, a remote controlled alarm system could be designed to include the step of automatically closing all of the vehicles power accesses to the automobile security process. This might even be enough of a safety feature to lower automobile insurance rates.

### CROSS REFERENCE TO RELATED APPLICATIONS

Not Applicable.

### BACKGROUND OF THE INVENTION

“A Mind of It's Own is a conceptual invention pertaining to the technologies in remote control keyless entry automobile alarm systems; and technological advancements in late model, power everything motor vehicles. Specifically the ability to open/close power windows, and sunroofs (when applicable) after the vehicles engine has been turned off, until one of the automobiles doors is opened. Problems with the aforementioned technologies include, but are not limited to: Locking an automobile while no longer inside the vehicle, leaves it difficult to discern whether or not all of the vehicles accesses are left entirely secure. This problem falls under the category of human error. I believe, however, that eliminating and/or lessening instances of human error is a major purpose of motivation to inventors of the past, present, and future.

### BRIEF SUMMARY OF THE INVENTION

“A Mind of It's Own” is a concept designed to better the protection of one of today's most valued yet frequently invaded consumer possessions; The Passenger Car. “A Mind of It's Own” combines and improves on two existing concepts in automobile security technologies. The intention of “A Mind of It's Own” is to greatly reduce, and potentially eliminate the consistency of a vehicle being locked, the alarm being armed and ready, yet one or more of the automobile's accesses remains open; an invitation to theft, burglary, and vandalism.

### BRIEF DESCRIPTION OF THE SEVERAL VIEWS OF THE DRAWING(S)

Not Applicable.

### DETAILED DESCRIPTION OF THE INVENTION

“A Mind of It's Own” is taking an existing concept in motor vehicle security (the remote control keyless entry concept). Combining that concept with an improvement on an existing advancement in automotive technology i.e. power window and sunroof (whenever applicable) motors remain operational after power has been removed from the vehicle itself, until one of the vehicle doors is opened. Modified to where; power window and sunroof motors remain operational until one of the automobile doors is locked.

Finally an improvement applied to the remote control keyless entry alarm system initiating the following 3 to 4 step process upon pressing the “lock” button on the keyless entry remote control.

1. All power accesses to the vehicle activate to close until a timer or sensor determines that they are secure.
2. The automobile doors lock and secure.
3. The automobile's power window and sunroof (when applicable) motors are deactivated.
4. The Automobile alarm is activated (when applicable).

What I claim as my invention(s) is/are; an improvement on an existing technology in late model automobiles; i.e. the ability to open and close a vehicles power accesses after the vehicle has been powered off until one, or all, of the vehicle doors is opened. Improved to: The ability to open and close an automobile's power accesses until one, or all, of the vehicle doors become(s) locked combined with

1. A modification to remote control keyless entry automobile security system, initiating the following 3 to 4 step process.

2. All power accesses to the vehicle activate to close until a timer or sensor determines that they are secure.

3. The automobile doors lock and secure.

4. The automobile's power window and sunroof (when applicable) motors are deactivated.

5. The Automobile alarm is activated (when applicable).
